(19) United States
(12) Patent Application Publication
(10) Pub. No.: US 2006/0240165 A1
(43) Pub. Date: Oct. 26, 2006

(54) Gel feed

(76) Inventor: Mark Geach, London (GB)

Correspondence Address: NIXON & VANDERHYE, PC, 901 NORTH GLEBE ROAD, 11TH FLOOR, ARLINGTON, VA, 22203, US

(21) Appl. No.: 10/537,048

(22) PCT Filed: Nov. 3, 2003
(86) PCT No.: PCT/GB03/04714

§ 371 Date: Nov. 8, 2005

(30) Foreign Application Priority Data
Nov. 1, 2002 (GB) 0225503.2

(51) Int. Cl. A23L 1/05

(52) U.S. Cl. 426/573

(57) ABSTRACT

The present invention provides a composition comprising a dry powdered diet which, when mixed with wet feed and/or with water, forms a gel. The composition may optionally include a liquid component. A gel feed comprising the composition is also provided.

The present invention relates to improvements in animal feed compositions, and in particular, to improvements in feed for aquatic animals, especially those kept in aquaria.

Food harvesting, processing, manufacture and storage may lead to a reduction in the nutritional value of the feed ingredients. Exposure to light, heat, pressure, mechanical actions, atmospheric conditions or irradiation may damage feed ingredients resulting in reduced quantities of nutrients and/or reduced bioavailability of important dietary components. Affected nutrients may include fat and water soluble vitamins, fat and water soluble carotenoids, immunomodulators and bioflavenoids.

As a result of this, the diets of captive species may not adequately reflect the nutritional diversity and bioavailability of the natural diet for a given species. This may result in nutritional restrictions and subsequent negative effects on growth, reproduction, health and sustainability of captive populations. This is of particular significance to species conservation programmes and in many areas of zoo and wildlife nutrition.

Carotenoids are pigments of plant origin and are known to act as powerful antioxidants. Certain carotenoids are additionally known to provide pigmentation and coloration of animal tissues. They are considered to be an important dietary component for many species.

Diets may require supplementation with additional amino acids to overcome amino acid restriction and to aid the provision of balanced protein within the ration.

It is known to add dry vitamin, mineral, carotenoid and amino acid powdered preparations to enrich feed. However, this has a number of disadvantages. Distribution of such powdered particles or fine aggregates on or within the feed is affected by factors such as feed particle size and adherence. Post enrichment settlement may occur, providing variance in feed quality, especially following storage, transport and distribution.

Liquid preparations containing vitamins, minerals, carotenoids and/or amino acids simplify enrichment and provide enhanced uniform distribution and adherence to the feed. In many cases the liquid may penetrate the feed surface and become strongly bound to the feed matrix.

In some formulations of the diet, a separate liquid supplement including a number of components in a liquid state may be supplied for addition to the feed at the time of mixing. Such liquids may include, but are not restricted to, amino acids, glucans, vitamins, minerals, carotenoids and oils/fats, all in a liquid form as an emulsion, solution or suspension.

The present invention seeks to address the problems or disadvantages associated with the known feed additives. The compositions according to the invention are preferably formulated to allow the simultaneous addition to feeds of highly bioavailable components in a liquid state, namely one or more of the following:
1. water soluble vitamins;
2. water soluble minerals;
3. aqueous soluble 1,3 and/or 1,6 beta glucans;
4. fat soluble vitamins in micelle form;
5. water soluble carotenoids;
6. fat soluble carotenoids in micelle form;
7. amino acids in the liquid phase which may be presented in the oil or water phase of the composition, the presentation of the amino acids in the oil phase will be in micelle form;
8. a balanced mixture of oils;
9. microparticulate water insoluble 1,3 and/or 1,6 beta glucans;
10. particulate algae;
11. powdered yeasts and algae; and
12. freeze dried feed, preferably marine feed, such as fish, crustaceans, artemia, copepods, mysis, krill, polychetes such as ragworm and lugworm.

The provision of water soluble vitamins in solution, fat soluble vitamins in micelles and amino acids in a liquid state in micelle and/or the aqueous phase provides a high degree of bioavailability and reduces the potential for chemical interactions which may reduce bioavailability following consumption. A balanced addition of oils of specific chain length may be used to further aid enrichment.

It has been shown, for example, that the use of a liquid carotenoid supplement presenting the carotenoid in micelle form in an emulsion has a high bioavailability and is able to result in change in skin coloration in animals, particularly in fish and reptiles. The performance of such emulsions may exceed that of dry formulations.

In a preferred embodiment, the liquid carotenoid supplement presenting the carotenoid in micelle form is provided separate from the dry powder composition. In another embodiment, the liquid carotenoid supplement is already added to the dry food, for example by spraying or by vacuum penetration. This allows the carotenoid to penetrate into the fat, providing enhanced bioavailability.

A further advantage is that the composition of the liquid additive product continues to protect the vitamins, carotenoids and the feed itself against oxidation in the post application stage.

The microparticulate water insoluble beta glucans preferably have a diameter of between 1 and 10 microns. It has been found that particles of this size have benefits over the currently available commercial products, because the relatively small particle size appears to enhance the bioavailability of the beta glucans.

Animals may be fed gel diets varying in formulation and hardness. To date, gel diet formulations have had a number of inherent disadvantages.

The known gel diet formulations are supplied as a dry powder—this has potential problems with regard to settlement and distribution as set out above.

The known gel diet formulations also contain single or multiple binders as feed additives. Such use may reduce the value of the diet by: (1) reducing the nutrient density of the food; (2) affecting diet digestibility and adsorption/absorption following consumption, for example, some carbohydrates are known to reduce protein uptake and utilization in fish, particularly in cold water marine fish; and (3) changing the nutrient profile of the diet.

Yet another disadvantage associated with known gel diets is that there is a frequent requirement to use heat in order to activate the gelling process. Hot or boiling water or steam is often recommended for reconstitution of the powder into a gel. This may cause degradation of delicate nutrients, reducing nutrient availability and altering the nutritional value of the food. Digestibility may be altered, and this may have undesirable effects in terms of health, growth and condition of animals.

The amounts of gel binders used in conventional gel diets will vary, but is frequently high in cases where a high gel strength is required.

Where cold gel setting processes have been used for the production of diets, the process involves the addition to the diet of synergistic gelling agents to vary the speed of gel setting. Such additives may include organic and inorganic compounds.

According to a first aspect of the present invention, a composition is provided which comprises a dry powdered diet which, when mixed with wet feed and/or with water, forms a gel.

In a preferred embodiment of the invention, certain components of the diet may be supplied in a liquid state, as described above.

The water used for forming the gel may vary in formulation and salinity and is preferably cold.

In a preferred embodiment, the composition comprises amino acids, glucans, vitamins, minerals, peptides, nucleotides, bioflavinoids, oils, polysaccharides carotenoids and/or lipids.

In another preferred embodiment, the composition according to the first aspect of the invention contains ingredients which have natural binding properties, for example particulate natural algae.

When used as a natural binder in the composition of the present invention, the particulate natural algae particle size may vary, and is preferably micronised to a size of between 30 microns and 160 microns in diameter. Algae may be derived from marine or freshwater sources, and may be naturally sized or ground following harvesting and drying. The use of algae in the feed composition provides natural binding properties by action of compounds such as carragenans.

Conventional binders, for example cellulose ethers such as hydroxyethylcellulose and methylcellulose, can be included in an amount between 0.001% and 3% by weight. Preferably, the conventional binders are included in an amount between 0.001% and 1%, more preferably between 0.001% and 0.1%, and most preferably between 0.001% and 0.01% by weight.

Powdered yeasts and algae may be subjected to processing prior to inclusion in the composition to enhance bioavailability of components. For example, the pretreatment of yeasts and algae can lead to an increase in the bioavailability of carotenoid pigments. The processing can be chemical or enzymatic.

In a further preferred embodiment, the composition may include feed attractants such as Betaine where an increase in palatability is desired.

In yet another preferred embodiment, the composition further comprises added fats. Preferably, the fats are derived from crustacea or other marine flora or fauna. The added fat provides a beneficial diet profile, especially where increased fat content in the feed is desirable, for example where the animal is undergoing veterinary treatment or has high metabolic demands.

In a yet further embodiment of the present invention, naturally or artificially enriched crustaceans and plankton may be added to the composition. This may include, but is not restricted to, Daphnia pulicaria enriched with Aphanizomenon flosaquae, and particularly crustaceans dried by refractance window drying systems or freeze drying.

The composition of the present invention may also include a conventional vitamin and mineral premix.

Compositions may also include organic minerals and minerals in a chellated form, such as selenium-methionine, where the mineral is bound to an amino acid (for example selanomethionine, which for example may be present in some yeasts). The use of organic minerals may aid mineral absorption, tissue retention and bioavailability.

Antioxidants and preservatives may be added to the composition to confer stability during storage, manufacture and during the post manufacture stage.

Where the composition according to the present invention has a separate liquid component, this liquid component has an aqueous phase containing water soluble vitamins, minerals, carotenoids and amino acids. Fats and fat soluble vitamins, carotenoids and amino acids are contained in a micelle “microencapsulated” form distributed evenly throughout the liquid component. Plankton and algae may also be included in liquid form. The liquid component preferably contains water, emulsifiers, antioxidants, and preservatives.

The formation of the micelle or “microencapsulated” fat soluble ingredients is achieved by the use of conventional emulsifying agents, such as Polysorbate 80, and by high speed blending or emulsification. The micelle structures will preferably contain hydrophobic fat soluble vitamins and carotenoids within a hydrophilic protective envelope structure.

Stabilization of the fat soluble phase and optimisation of micelle distribution is achieved by the inclusion of conventional stabilizing agents, such as monopropylene glycol. The use of such stabilizing agents reduces the potential for product turbidity and affords excellent product clarity.

Preservation of the solution may be achieved by the use of conventional preservatives, such as phosphoric acid and potassium sorbate. This prevents the growth of bacteria, fungi and yeasts.

Antioxidants may also be added to the composition to aid stability. Examples of such antioxidants include ascorbyl polyphosphate and butylated hydroxy-toluene. Antioxidants prevent or minimize the loss of the active components of the composition. The incorporation of antioxidants thereby extends the shelf life of the composition and provides protection to the finished product in the post application phase.

In a further embodiment of the invention, cellulose, gum and sugar derivatives are added to the liquid composition to aid dispersion within or onto feeds in certain applications by virtue of their ability to increase solution viscosity and adherence. These products are not required for emulsification in this composition.

The fat and water soluble vitamins used in the composition may be a single or multiple. The quantity and ratio of vitamins included will be dependent on the desired vitamin content of the feed produced using the composition of the present invention.

Similarly, the type and quantity of a number of optional additives included in the composition will vary, depending upon the desired make-up of the resultant feed product. Such variable additives include fat and water soluble carotenoids, aqueous soluble beta 1,3 and/or 1,6 glucans, specific chain length oils, and amino acids.

In one embodiment of the invention, suspensions of glucans and immunomodulating agents including algae are used.

In another embodiment, the amino acids are added in a free form to increase bioavailability.

The potassium and/or calcium ion content of the composition according to the present invention may be varied in order to aid the setting process or to give rise to firmer setting gel, especially where the composition includes carragenans.

It has been found that the composition according to the first aspect of the present invention affords stability to the active components during storage, application and post application period.

The composition provides a uniform dispersion of the various components within the composition and this aids optimal distribution of the components when the composition is applied to feeds.

The presence of the uniform micelles aids the uptake of fats and fat soluble vitamins carotenoids and amino acids from the diet at the level of the digestive tract. This is combined with the simultaneous presentation of water soluble vitamins, carotenoids and amino acids providing excellent bioavailability. The presence of amino acids in a liquid free form provides a high degree of bioavailability without the requirement for hydrolysis.

Thus, it is clear that the gel feed produced using the composition according to the first aspect of the present invention affords a number of important advantages over the known gel feed.

According to a second aspect of the present invention, a gel feed product is provided, comprising the composition according to the first aspect of the present invention, mixed with wet feed and/or with water.

This gel feed product may be used for a variety of dietary applications. The ratio of composition to wet feed or water can be varied, depending upon the desired end product.

This gel feed has a number of advantages. Firstly, its formation does not require heat. This means that the additives that may be included in the gel feed will not be denatured or spoilt. This also makes it easier to include medicines in the gel feed.

Secondly, this cold setting instant gel feed may be prepared rapidly and may be fed as a moist crumb, or may be compressed to form a block and the block may be cut into pieces of a size and shape which suits the species being fed. Alternatively, the gel may be pressed into feeders such as corals for marine fish. The gel may also be pressed onto rope or alternative feeders for presentation. The feed can also be presented in such a way that only a certain species in the water can or will access it, thereby allowing targeted feeding.

Thirdly, the easily manipulated gel can be pressed or extruded into the desired shape, which it will then maintain for a relatively long period as, the gel feed is relatively stable in water and only gradually disintegrates. This is in contrast to conventional gel feed materials which tend to be rather rubbery and which are not particularly malleable. This means that the conventional gels are very difficult to manipulate into desired shapes or products, as one can do with the gel of the present invention. While the gel of the present invention may be pressed into a given shape or onto a support means such as rope, the conventional gels need to be set in the appropriate shape or on a support.

Fourthly, the gel according to the present invention does not include the conventional gelling agent gelatin. The inclusion of gelatin, which is used in many of the known gels, is undesirable as gelatin is generally not made from proteins which form part of the animals' natural diet.

The conventional gel feeds, such as the Mazuri® Herbivore Aquatic Gel Diet for fish are based upon alfalfa and fish meal. In contrast, the gels according to the present invention are based upon natural algae, which have a high organic mineral content, and natural sources of crustaceans. By avoiding the terrestrial and fish sources used in the conventional gel feeds, a significantly more effective feed is achieved. The algae used in the present invention preferably have 20-35% dry matter content of organic minerals and are a natural source of complex carbohydrates.

Compared to when using convention gel feeds to feed fish, such as reef fish, the gel feeds of the present invention lead to a significantly lower incidence of obesity. Conventional gel feeds have been shown to lead to abdominal deposits of fat which the fish appear to be unable to shift. These fish fed on gel feeds according to the present invention do not exhibit such abdominal fat deposits and, when fish are put on the gel feeds of the invention, the abdominal fat deposits from the conventional gel feeds are observed to reduce. Thus, it would appear that the use of more natural food sources, such as algae and crustaceans leads to healthier fish and less obesity.

The use of the gel feed within corals, on rope or in/on an alternative holder such as a mesh or bobbin can target feed animals and will also increase the period of food availability, reducing competitive feeding behaviour and allowing natural grazing. This is particularly important when feeding fish in captivity.

In a particularly preferred embodiment, the various constituents of the gel product are included in as particles of different sizes. For example, particles can have a particle size ranging from 1-3 microns to of the order of 3 mm. The different particle sizes have been found to better mimic the natural diet of varying particle sizes. What is more, the varying particle size can encourage selective and non-selective grazing by the animals. For example, the animals may be attracted to the gel feed by larger chunks of algae or crustacean material which protrude from the gel as it gradually breaks down. They then start feeding on the gel, either selecting to eat particular components or indiscriminately grazing on the gel as a whole.

Finally, in yet another embodiment of the invention, the gel is dried and produced in the form of flakes or pellets. The dried gel re-hydrates when added to the water.

In order that the present invention may be better understood, a specific example will now be described, by way of illustration only.

This specific example of a gel feed according to the present invention is an omnivore feed intended for marine fish.

The composition comprises the following components or ingredients:

| | | |
|---|---|---|
| Fucus 60 micron | 481.00 | g |
| Nori micronised | 3868.00 | g |
| Dulse micronised | 1040.00 | g |
| Spirulina | 204.00 | g |
| Fishvits premix | 210.00 | g |
| Nori fine flake | 808.52 | g |
| Shrimp meal | 1.214 | kg |
| Aphanizomenon flos-aquae | 133.77 | g |
| Beta glucan premix | 428.75 | g |
| Phaffia | 330.28 | g |
| Daphnia pulicaria RF dried | 1030.91 | g |
| Soya isolates | 247.91 | g |
| Selanomethionine as yeast | 3.00 | g |

The above components were blended so as to form a homogeneous powder. Then the powder was mixed with defrosted or fresh wet fish feeds in a ratio of 50:50 by weight.

The mixture was then blended in a paddle mixer for a short period, preferably between 10 seconds and 2 minutes in most cases. This led to the formation of gel in the form of semi-moist “crumbs”.

Water was then added at 10-25 mls for each 100 g of dry diet used in the formulation whilst mixing again for a short period (10 seconds to 2 minutes in most cases). This formed a gel in the form of moist “crumbs”.

The crumb formed in that way may be fed immediately and may be formed by hand or by machine into blocks or balls. These blocks or balls may be cut with a knife into pieces of a size and shape to suit the animals being fed. Alternatively the block may be pressed onto a feeder/rope and hung or placed within the water as a food source.

In many cases the gel lasts for several hours as a gel. Advantageously, there is very little clouding of the water or gel diet breakdown whilst the gel feed is in the water.

Furthermore, the gel sets instantly without the need for it to be chilled. This means that the gel is very easy to manipulate and handle. This is particularly useful when the gel is to be applied to ropes, meshes and the like, which would be difficult, if not impossible, if the gel needed to chill in order to set. It also means that the gel will not quickly “melt” at room temperature or warmer.

A further advantage of the gel according to the present invention is that it can be frozen without loss of its nutritional content, and the defrosted gel retains its gel structure and gel properties, so that a frozen and defrosted gel according to the present invention is virtually indistinguishable from the unfrozen gel. This is useful for storage of the gel product. The gel may be frozen on support structures such as ropes and the like.

Naturally, the precise make up of the gel feed will depend upon the species to be fed, and the skilled person would have no difficulty determining the beneficial preparations for any given species. For example, the preparation described in detail above is particularly well suited to reef fish.

1. A composition comprising a dry powdered diet which, when mixed with wet feed and/or with water, forms a gel.

2. A composition as claimed in claim 1, further comprising a liquid diet component.

3. A composition as claimed in claim 1, wherein the diet comprises one or more of vitamins, minerals, 1,3 and/or 1,6 beta glucans, carotenoids, amino acids, oils, yeasts, algae and freeze-dried feed.

4. A composition as claimed in claim 1, wherein the composition includes a natural binder.

5. A composition as claimed in claim 4, wherein the natural binder is particulate natural algae.

6. A composition as claimed in claim 2, wherein the liquid component has an aqueous phase containing water soluble vitamins, minerals, carotenoids and/or amino acids.

7. A composition as claimed in claim 2, wherein the liquid component has micelles containing fats, fat soluble vitamins, carotenoids and/amino acids.

8. A composition as claimed in claim 2, further comprising plankton and/or algae in liquid form.

9. A composition as claimed in claim 1, wherein the composition comprises natural sources of algae and crustaceans.

10. A gel feed comprising a composition as claimed in claim 1 mixed with wet food and/or water.

11. A gel feed formed on to a rope or in the form of a feed block.

12. A gel feed as claimed in claim 10 wherein the gel is formed on to a rope or in the form of a feed block.

13. A gel feed as claimed in claim 10, wherein the feed is frozen.

14. A method of forming a cold setting gel feed comprising mixing a composition as claimed in claim 1 with a wet food and/or water.
